(19) United States
(12) Patent Application Publication
(10) Pub. No.: US 2004/0049608 A1
(43) Pub. Date: Mar. 11, 2004

(54) Apparatus and method for forming image

(75) Inventor: Atsushi Sakurai, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/234,387

(22) Filed: Sep. 5, 2002

(51) Int. Cl. G06F 3/00

(52) U.S. Cl. 710/5

(57) ABSTRACT

An image forming apparatus 1 which copies and outputs an input image has an accumulating unit 14 for accumulating input image data and a temporary storage unit 22, 22a, 13, 13a whose initializing time is shorter than that of the accumulating unit 14. When the initialization of the temporary storage unit 22, 22a, 13, 13a is completed to become operable before completing the initialization of the accumulating unit 14, a copying action is started while accumulating input image data in the temporary storage unit 22, 22a, 13, 13a in place of the accumulating unit 14.

### BACKGROUND OF THE INVENTION

1. Field of the Invention

The present invention relates to an apparatus and method for forming an image, and is applicable to, for example, digital copy machines having a hard disk drive.

2. Description of Related Art

In digital copy machines having an electronic sorting function, a way is employed in which image data, which are read through a scanner is temporarily accumulated, and the pages are sorted, and then output in the form of printing (hereinafter, referred to “print-output”). Since a large capacity is needed for accumulating image data for sorting purposes, a hard disk drive is employed as a device for performing this accumulation. Further, as means for temporarily storing image data, which is used in the course of processing the image data, semiconductor memories are used. There is a tendency of the capacities of semiconductor memories increasing because of: increase in image data amount caused by the tendency of picture image becoming high quality; decrease in prices of semiconductor memories; and so on.

On the other hand, in the field of the digital copy machines, it is strongly required to reduce the initializing time of a copy machine (The term “initializing time” as used herein refers to a time spent from the moment when the power is turned on till the moment when the copy machine becomes a state in which a copying action can be started. The time needed for recovering from a sleep mode falls under the category of the initializing time.).

However, conventional apparatuses adopt a way in which, as shown in FIGS. 13 and 14, a copying action can be started only when all of: completion of the initialization of the constituent members other than the hard disk drive (the constituent members including the semiconductor memory); completion of heating of the fixing unit of the printer (warming up); and completion of initialization of the hard disk drive. Accordingly, if any one of these three events takes a while (i.e., long time), the event becomes a factor of hindering the shortening of the initializing time of the entire apparatus.

As such a hindering factor, the warming-up time of the printer had been mentioned in the past, but introduction of an induction heater has shortened the warming-up time. In contrast, the initializing time of the hard disk drive has not been shorted so much yet. This is because the hard disk drive has a motor therein, and accumulation of data in the hard disk drive can be started only when the motor reaches a state in which the motor revolves stably, so that a long time is needed from the turning-on of the power till the hard disk drive can be used for the data accumulation. Due to this mechanical restriction, in many hard disk drives, at present approximately 20 seconds is spent at the longest from the turning-on of the power till the state where the hard drive becomes operable is reached, and also in the future it seems difficult to shorten the time. Thus, in recent years, the initializing time of the hard disk drive has become a major factor of hindering shortening of the initializing time of the entire copy machine.

Under the above circumstances, in the field of image forming apparatus having a mechanical element such as a hard disk drive, the problem to be solved in recent year has shifted to an issue of how the initializing time of the entire image forming apparatus can be shortened under the above-mentioned restriction applied on the accumulating unit (i.e., hard disk drive).

### SUMMARY OF THE INVENTION

An object of the present invention is to provide an image forming apparatus and image forming method, which can shorten the initializing time of the entire apparatus.

To achieve the above object, the present invention provides an image forming apparatus in which an input image data is accumulated and an outputting action (for example, copying action) is performed on the basis of the accumulated image data, comprising:

an accumulating unit (for example, hard disk drive) for accumulating input image data;

a temporary storage unit (for example, semiconductor memory such as page memory, main memory, and so on) whose initializing time is shorter than the initializing time of the accumulating unit;

a control unit (for example, memory control unit) which causes, when the temporary storage means becomes operable before completion of the initialization of the accumulating unit, the accumulating action of the input image data and the outputting action (for example, copying action) of the accumulated image data to start while accumulating input image data in the temporary storage means in place of the accumulating means.

Owing to this constitution, before the activation (i.e., initialization) of the accumulating unit whose initializing time is long, the accumulating action of the input image data and outputting action of the accumulated image data can be started by accumulating input image data in the vacant area of the temporary storage unit in place of the accumulating unit.

### BRIEF DESCRIPTION OF THE DRAWINGS

FIG. 1 is a functional block diagram showing a configuration of an image forming apparatus according to the first to third embodiments of the present invention;

FIG. 2 is a flowchart showing the actions of the image forming apparatus according to the first embodiment of the present invention;

FIGS. 3A to 3C are memory maps showing how the memories are used in the image forming apparatuses according to the first to third embodiments of the present invention;

FIGS. 4A to 4C are flowcharts showing a management procedure for vacant areas in the image forming apparatuses according to the first to third embodiments of the present invention;

FIG. 5 is a view showing an example of a vacant area management table in the image forming apparatus according to the first to third embodiments of the present invention;

FIGS. 6A and 6B are schematic views each showing a transfer path of the image data when the copying action is performed in the image forming apparatus according to the first to third embodiments of the present invention;

FIG. 7 is a time chart which shows time-based relationships among the actions and operations performed in the image forming apparatus according to the first embodiment of the present invention;

FIG. 8 is a flowchart showing the sequence of actions of the image forming apparatus according to the second embodiment of the present invention;

FIG. 9 is a time chart which shows time-based relationships among the actions and operations performed in the image forming apparatus according to the second embodiment of the present invention;

FIG. 10 is a flowchart showing the actions of the image forming apparatus according to the third embodiment of the present invention;

FIG. 11 is a time chart which shows time-based relationships among the actions and operations performed in the image forming apparatus according to the third embodiment of the present invention;

FIG. 12 is a time chart which schematically shows mutual relationships among the sequences of the actions according to the first to third embodiments of the present invention in comparison with conventional art;

FIG. 13 is a flowchart showing the actions of a conventional apparatus; and

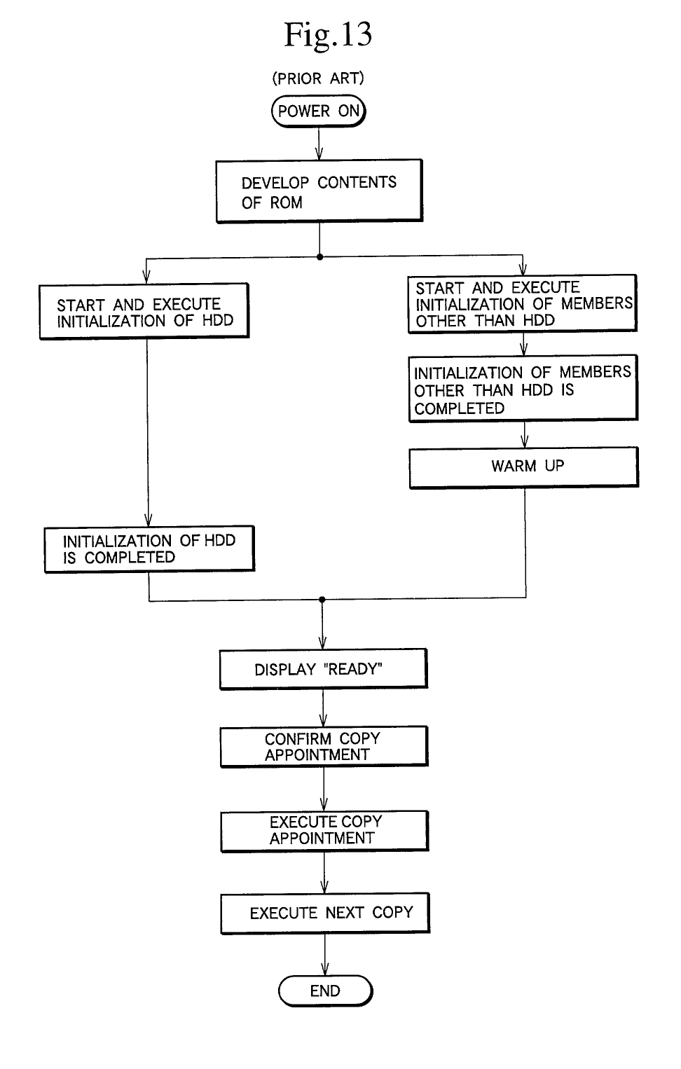

FIG. 14 is a flowchart showing time-based relationships among the operations and actions in the conventional apparatus.

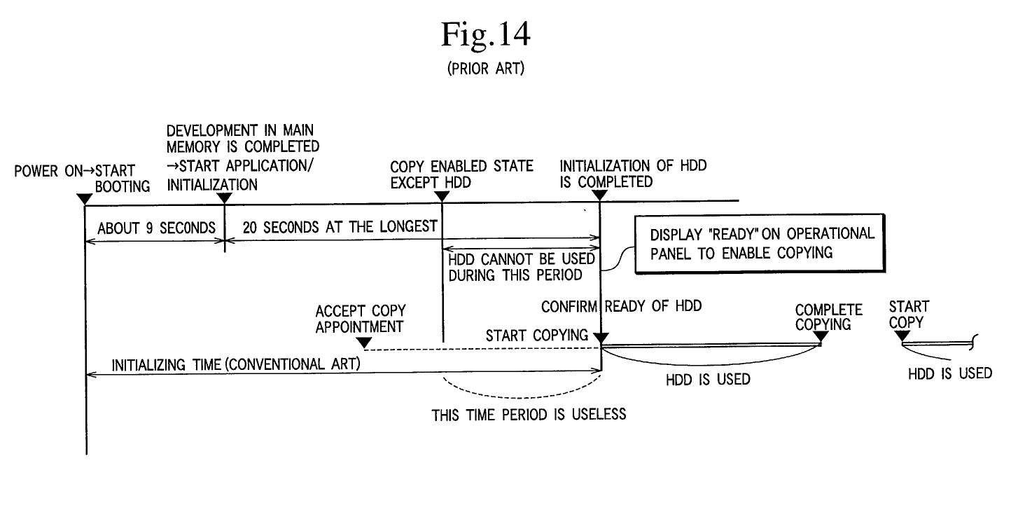

### BEST MODE FOR CARRYING OUT THE INVENTION

(A) First Embodiment

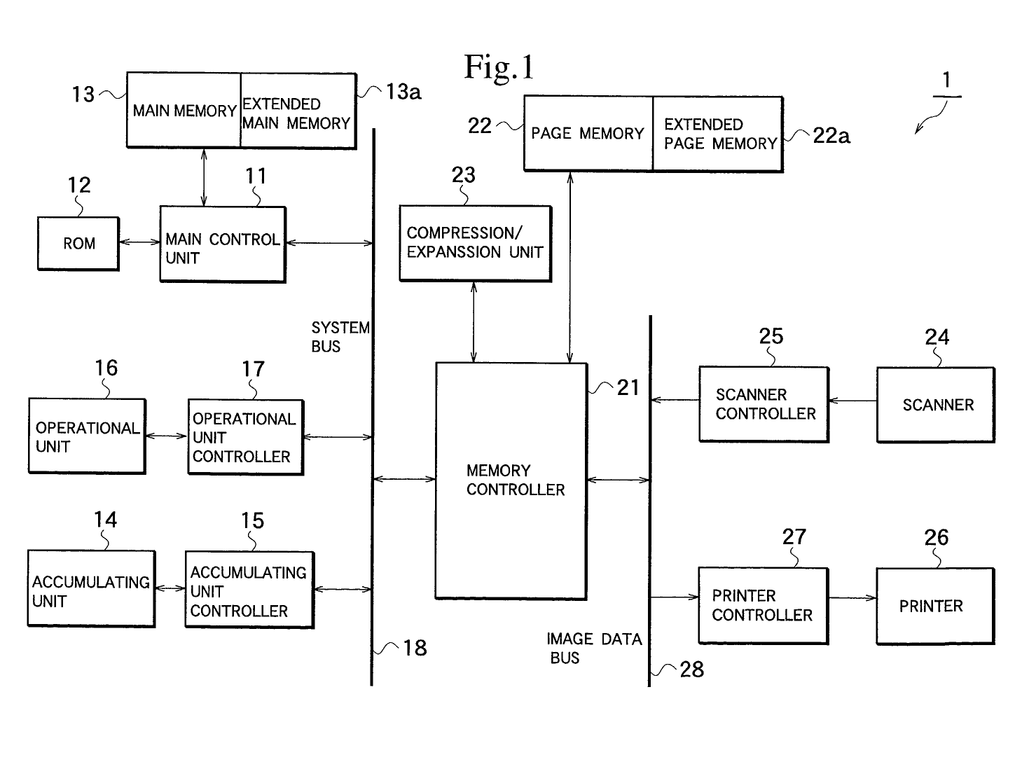

Hereinafter, with reference to FIGS. 1 to 8, and FIG. 12, a first embodiment of an image forming apparatus 1 according to the present invention will be described.

(A-1) Constitution of First Embodiment

FIG. 1 shows an image forming apparatus 1 according to the first embodiment. The image forming apparatus is roughly configured in such a manner as to include a main control unit 11, a ROM (Read Only Memory) 12, a main memory 13, an extended main memory 13a, an accumulating unit 14, an accumulating unit controller 15, an operational unit 16, an operational unit controller 17, a memory control unit 21, a page memory 22, an extended page memory 22a, a compression/expansion unit 23, a scanner 24, a scanner controller 27, a printer 26, and a printer controller 27; these members being connected via a system bus 18 and an image data bus 28 in a manner as shown in FIG. 1.

The main control unit 11 is a unit which is adapted to control the entire image forming apparatus 1, and which includes a CPU and its related peripheral circuits.

The ROM 12 is a storage element which is connected to the main control unit 11 and which is adapted to exclusively perform reading-out of data, and to hold programs for controlling the entire apparatus.

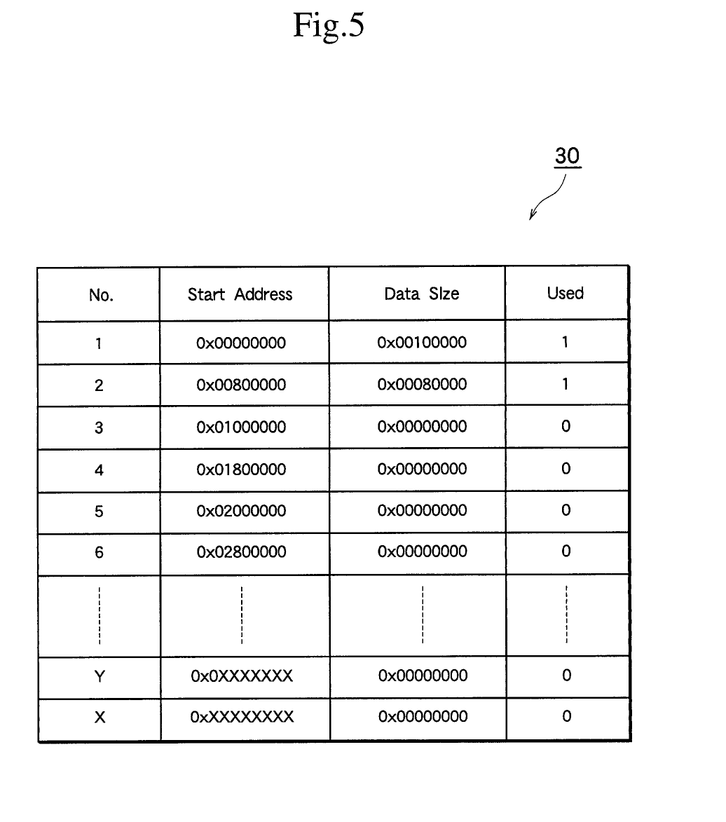

The main memory 13 is a memory which is connected to the main control unit 11, and adapted to develop various programs for controlling the image forming apparatus 1. The main memory 13 also includes a RIP (raster image processor) area which is used when the network is activated. Further, the vacant area management table 30 shown in FIG. 5 is also stored in the main memory 13. The extended main memory 13a is an add-on memory which is optionally connected to the main memory 11 and adapted to extend the memory area for the RIP in the main memory 13. Each of the main memory 13 and the extended main memory 13a is constituted by, for example, a semiconductor memory, and controlled by the main control unit 11.

The accumulating unit 15 is a unit which is adapted to accumulate image data and constituted by, for example, a hard disk drive (Note that the term “hard disk drive” as used herein refers to an entire hard disk device which contains a hard disk therein, instead of referring to merely a driving unit for driving the hard disk, which constitutes a part of the entire hard disk device. A hard disk drive is occasionally referred to as “HDD” in this specification.). Note that usually image data are accumulated in the accumulating unit in a compressed form. The accumulating unit controller 15 is a unit which is connected to the accumulating unit 14 and to the system bus 18 so as to control: transfer of data to the accumulating unit 14; reading-out of data from the accumulating unit 14; and so on.

The operational unit 16 is a unit to which information is input by the user, and which is constituted by, for example, an operational panel. The operational unit controller 17 is a unit which is connected to the operational unit 16 and the system bus 18 and adapted to control: transfer of the information, which is input from the operational unit 16 to the main control unit 1 via the system bus 18; and display of the information on the operational panel serving as the operational unit 16.

The system bus 18 is a common bus which is used to transfer display control data, and which connects the main control unit 11, the accumulating unit controller 15, the operational unit controller 16, and the memory control unit 21 in a manner as shown in FIG. 1.

The memory controller 21 is a unit which is connected to the page memory 22 and the compression/expansion unit 23, and adapted to control the page memory 22, the extended page memory 22a, and a compression/expansion unit 23. The memory control unit 21 is also connected to the image data bus 28 and the system bus 18, and adapted to perform: control on giving and receiving image data with respect to the scanner 24 and printer 26 through these buses; control on giving and receiving of the control data with the main control unit 11; and so on.

The page memory 22 is a unit which functions as a buffer for temporarily holding image data transferred from the scanner 24, or image data to be transferred to the printer 26. The extended page memory 22a is an add-on memory which is optionally connected to the page memory 22, and adapted to increase the memory capacity of the page memory 22. Each of the page memory 22 and the extended page memory 22a are constituted by, for example, a semiconductor memory. The compression/expansion unit 23 is a unit which is adapted to compress image data and to expand compressed image data to image data before compression.

The scanner 24 is a unit which is adapted to read image and to generate image data from the image thus read. The scanner controller 25 is a unit which is connected to the scanner 24 and to the image data bus 28, and which is adapted to control the scanner 24 and also to transfer the image data read at the scanner via the image data bus 28 to the memory control unit 21, or the like. The scanner controller 25 also performs a part of an image processing action.

The printer 26 is a unit which forms an image on the basis of image data and performs printing the image on a printing medium such as copy paper. The printer controller 27 is connected to the printer 26 and the image data bus 28, and adapted to control the printer 26 on the basis of the image data obtained via the image data bus 28 so as to cause the printer 26 to perform a printing action. The scanner controller 26 also performs a part of image processing action.

The image data bus 28 is a common bus which is adapted to transfer chiefly image data, and connects the scanner controller 25, the printer controller 27, and the memory control unit 21 in a manner as shown in FIG. 1.

(A-2) Operation of First Embodiment

The operation of the image forming apparatus 1 according to the first embodiment of the present invention will be described below.

(A-2-1) Overall Operation

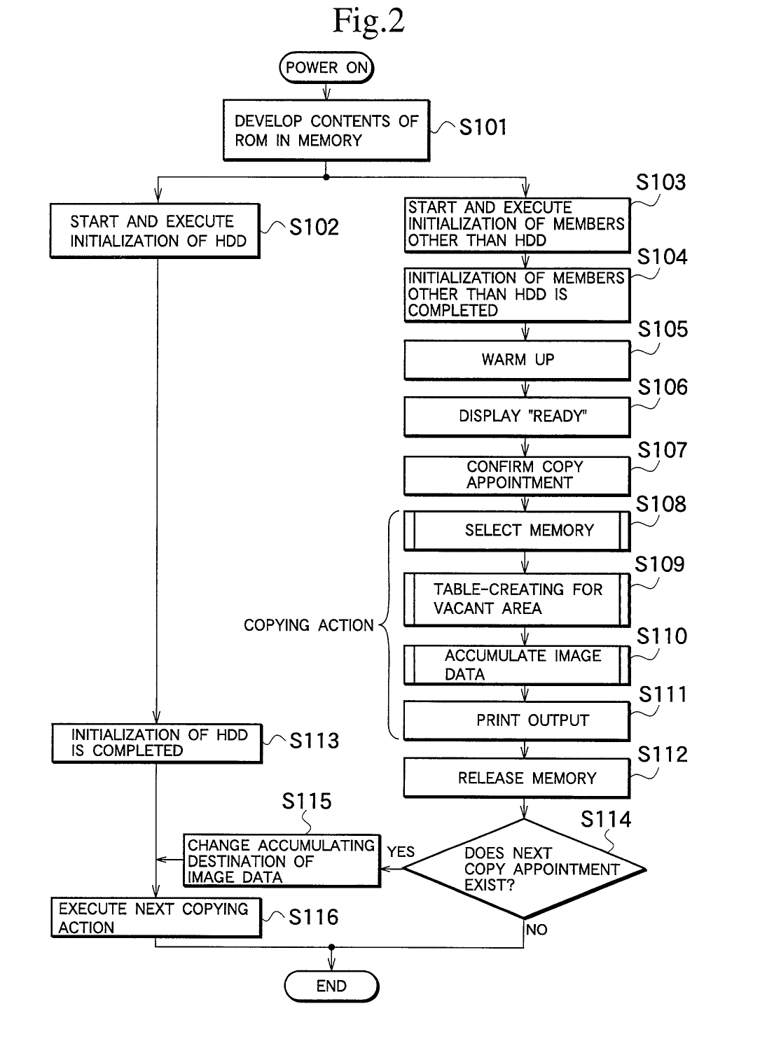

FIG. 2 is a flowchart which shows an overall operation of the image forming apparatus 1.

When the power is turned on, the application software (hereinafter, occasionally referred to as simply “application”), which has been stored in the ROM 12, is developed in the main memory 13 (S101). Then the application thus developed is actuated, whereby the initialization of the image forming apparatus 1 is started. Specifically, the initialization of the accumulating unit 14 is started and executed (S102), and in parallel with this initialization, initialization of the members constituting the image forming apparatus 1 other than the accumulating unit 14 is started and executed (S103). Further, warming-up of the printer 26, that is, supplying heat to a fixing unit (not shown) of the printer 26 is performed till the temperature of the fixing unit reaches a temperature sufficient for printing. When initialization of the constituting members of the image forming apparatus 1 other than the accumulating unit 14, and the warming-up of the printer 26, are completed (S104, S105), a character string “Ready”, which informs the user that a copying action can be executed, is displayed on the operational unit 16 (S106).

Next, a confirmation is made as to whether or not an appointment for copying (hereinafter, referred to as “copy appointment”) is registered (S107); and when a copy appointment is registered, the copying action (SlO8 to S111) is executed. Specifically, a judgement is made as to whether or not the manuscript is monochrome or color, so as to calculate image data amount (required data amount), whereby a memory having a vacant area capable of accumulating the required data amount is selected (S108). Next, a table-creating is performed with respect to each of the vacant areas (S109) so as to form a vacant area management table 30. Then, image data is accumulated in the vacant area by using the vacant area management table 30 (S110), and print-outputting is performed based on the image data thus accumulated (S111). When the copying action is completed, the memory used for the copying action is released (S112), and thereafter the released memory is used for its inherent processing. At a moment in the course of executing the above-mentioned operations, initialization of the accumulating unit 14 is completed (S113).

Thereafter, it is confirmed whether or not a next copy appointment is registered (S114). When the next copy appointment is registered, the copying action for the next copy appointment is executed while designating the accumulating unit 14 as an accumulating destination (S116). Similarly, with respect to copying actions associated with its subsequent copy appointments, the copying actions are executed while designating the accumulating unit 14 as an accumulating destination of the image data.

(A-2-2) Selection of Memory to be Data Accumulating Destination

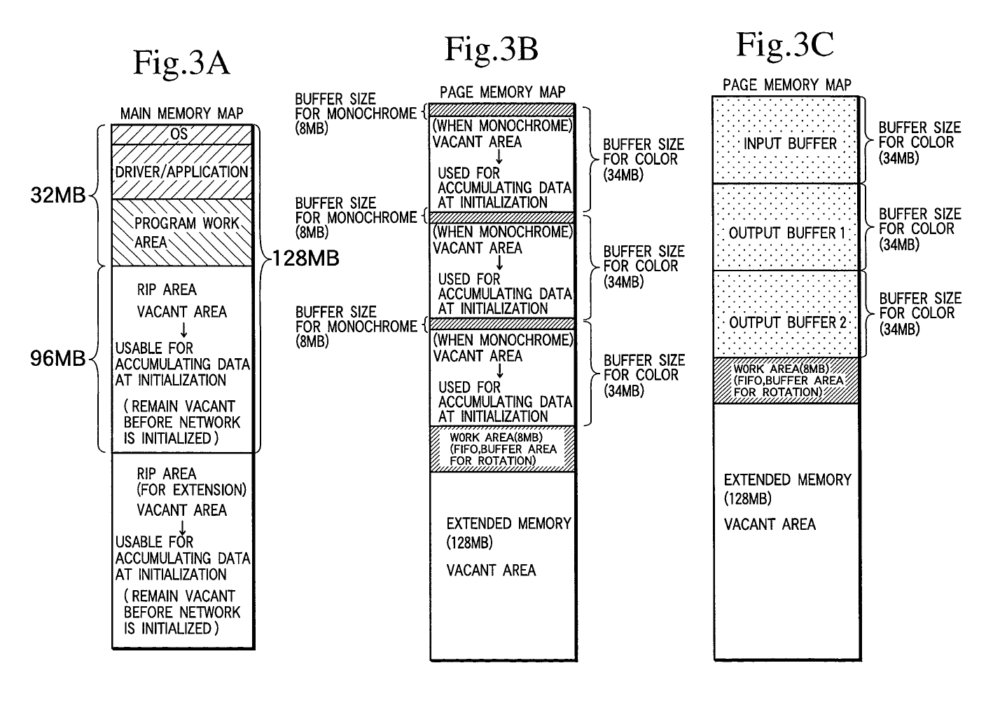

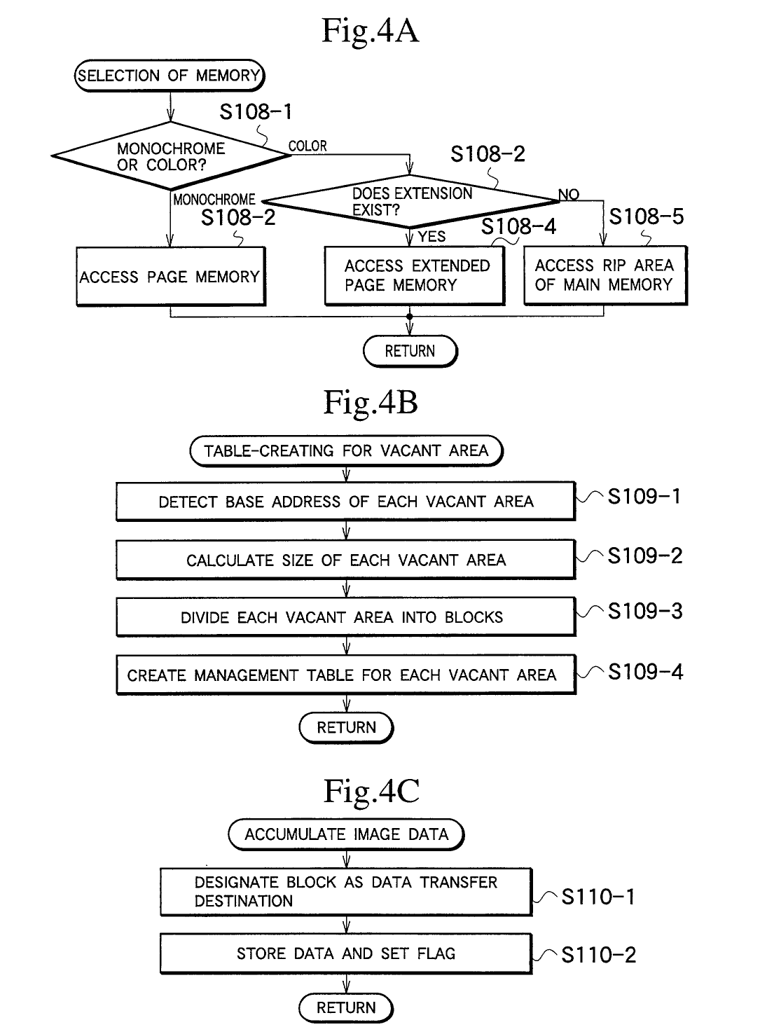

Referring to the FIGS. 3A to 3C and FIG. 4, the procedure, executed at the step S106, for selecting a memory having a vacant area to which image data is stored will be described in detail.

(A-2-2-1) Criteria for Selecting Memory

Which vacant area of a memory should be selected as an accumulating destination is determined on the basis of the relationship between data amount of image data to be accumulated (i.e., required image data) and the size of the vacant area (i.e., allowable data amount). The required data amount and the allowable data amount are greatly different depending on the types of the manuscript to be copied, that is, depending on whether the manuscript is monochrome or color. Accordingly, each of the required data amount and allowable data amount is reviewed with respect to the cases of monochrome and color; and then explanations will be made on which memory is selected as an accumulating destination. Note that the required data amount is calculated on the basis of how much data is required for performing the copying action for 20 seconds. The time of 20 seconds is determined while considering that approximately 20 seconds is spent from the turning-on of the power till the state where the hard disk becomes a usable state is reached.

(A-2-2-2) Required Data Amount

In general, in the case of monochrome images, the data amount of image data, in which one pixel is represented by one bit, is 4 MB (megabyte) for one sheet of A4 size. By contrast, in the case of color images, data amount of the image data amounts to 100 MB for one sheet of A4 size. This is because one pixel consists of three color elements of R (red), G(green) and B(blue) each having 8 bits so that one pixel has 24 bits in total. Since the data size without compression is so large that it takes a long time to transfer the data; in actual operations, the data is compressed to approximately ⅕ (one fifth) to ⅙ (one sixth) as large as the normal size, and then the data thus compressed is transferred and accumulated. Accordingly, the data size after compression is approximately 0.8 MB (⅕ size) in the case of monochrome, and approximately 17 MB (⅙ size) in the case of color.

In the case of a copy machine capable of reading and printing a monochrome manuscript of A4 size at a rate of 45 pages per minute, the number of pages of the manuscript which is input for 20 seconds is 15. Assuming that the image size (i.e., data size of image data) after compression is 0.8 MB per sheet, the data amount amounts to 12 MB (i.e., 0.8 MB/sheet×15 sheets). Accordingly, in the case of monochrome, if a memory has a vacant area larger than the required data amount of 12 MB, the data accumulation for 20 seconds can be executed by using the memory.

In contrast, in the case of a copy machine capable of reading and printing color manuscript of A4 size at a rate of 10 sheets per minute, the number of pages of manuscripts input for 20 seconds is approximately four. Assuming that the image data size is 17 MB per sheet, the data amount amounts to 68 MB for 20 seconds (i.e., 17 MB/sheet×4 sheets). Accordingly, in the case of color, if a memory has a vacant area larger than the required data amount of 68 MB or more, data accumulation for 20 seconds can be performed while using the memory.

(A-2-2-3) Allowable Accumulation Amount and Memory to be Determined as Accumulating Destination

On the other hand, an allowable accumulation amounts in the memory is calculated in the following way. Specifically, the allowable amount is calculated on the assumption that the capacity of the page memory is 128 MB. This is because, in recent years, there is a tendency of the capacities of memories, equipped in digital copy machines, increasing. This tendency is caused by: increase of the data amount brought by the tendency of most images becoming colored; the tendency of the performance of MPF (multi function peripheral) becoming high; and reduction in prices of memories. Accordingly, many apparatuses are equipped with a page memory of 128 MB.

It is assumed here that, in both of the cases of monochrome and color, a page buffer containing one page for input, two pages for output is set in a manner as shown in FIGS. 3B and 3C. In this case, in the case of monochrome, out of the total capacity of 128 MB of the page memory 22, 24 MB is used for the three page buffers in total (8 MB for A3 size×3) (Note that, in FIG. 3B, the reason why the input and output buffers for monochrome of 8 MB are disposed with the spacings of 34 MB between neighboring buffers, instead of being disposed contiguously to each other, is that it is necessary to ensure that the page memory can cope with both of monochrome and color.), 8 MB for the work area; thus 32 MB in total being used for the copying action. Accordingly, the vacant area which can be used for accumulating the image data is the remaining area of 96 MB. This vacant area of 96 MB is much larger than the required data amount of 12 MB. The above review reveals that, in the case of monochrome, the vacant area in the page memory 22 can be used for the accumulating destination of the image data.

In the case of color, as shown in FIG. 3C, out of the total capacity amount of 128 MB, 102 MB for the three page buffers (34 MB of A3 size×3) and 8 MB for the work area; thus 110 MB in total being used for the copying action. Accordingly, the vacant area which can be used for accumulating the image data is the remaining area of 18 MB. This vacant area of 18 MB does not reach the required amount of 68 MB by far, and slightly exceeds the compressed data amount of one page of the A4 size color manuscript. Accordingly, if data compression cannot be performed successfully, or if the manuscript contains a plurality of pages; the memory cannot cope with such cases. Thus the capacity of the page memory is insufficient for actual color printing.

To overcome the above inconvenience, we notice the phenomena that the RIP (raster image processor) area is kept unused during the period when the copy machine is being activated (more specifically, during the period when the accumulating unit is activated). The reason why the RIP area is kept unused is as follows: Since it is usual that a longer time is spent for activating the network than for activating an accumulating unit, data has not entered the RIP area from the network when the accumulating unit is activated. In view of this phenomena, we intend to utilize the RIP area for copying actions.

For example, as shown in FIG. 3A, when a memory of 128 MB is equipped in the main memory 13, assuming that 32 MB is used for the program area for developing the program read out of the ROM 12 and for its work area, a vacant area of 96 MB, including an area used for the RIP, exists. This size corresponds to five pages or more of the compressed data size of color image, thus exceeding the 68 MB required for accumulating the image data of 20 seconds. The above review reveals that, in the case of color, the vacant area in the RIP area of the main memory 13 can be used as an accumulating destination of the image data.

Note that, where the extended page memory 22a is added to the page memory 22, the extended page memory 22a is used before using the RIP area of the main memory 13. When the extended page memory 22a is used before using the RIP area, accumulation of image data is started firstly at the extended page memory of 128 MB, so that the number of pages can be further increased.

(A-2-2-4) Concrete Actions in Selection of Memory

Based on the above selecting criteria, a memory which serves as an accumulating destination of image 115 data is selected at the step S108. The actual actions executed when selecting the accumulating destination are shown in FIG. 4A. First, a judgement is made as to whether the manuscript specified by a copy appointment is monochrome or color (S108-1). When the judgment made at the step S108-1 is that the manuscript is monochrome, the vacant area of the page memory 22 is accessed so as to use the vacant area in the page memory 22 as an accumulating destination (S108-2).

In contrast, when the judgement made at step S108-1 is that the manuscript is color, it is judged whether or not an extended page memory 22a is connected to the page memory 22 (S108-3). When the judgement at the step S108-3 is YES, the vacant area in the extended page memory 22a is accessed (S108-4); whereas, when the judgement at the step S108-3 is NO, the RIP area in the main memory 13 is accessed (S108-5).

Note that, while not shown in the drawings, where the extended main memory 13a is connected to the main memory 13, the following steps are performed.

Specifically, after the judgement of NO is made at the step S108-3, a further judgement is made as to whether or not the extended main memory 13a is connected. When the extended main memory 13a is connected, the extended main memory 13a is accessed before accessing the RIP area.

Note that the above-mentioned order in which the memories are used is only an example, and accordingly the order is not restricted thereto. For example, in the above description, in the case where the manuscript to be read is monochrome, when a vacant area exists in the page memory 22, the vacant area in the page memory 22 is used preferentially even if a vacant area existing in another memory has an allowable accumulation amount exceeding the required data amount. However, in this case, instead of using the page memory 22, the vacant area existing, for example, in the RIP area may be used preferentially.

After completing access to any one of the vacant areas via the above procedure, the processing goes to the step 109 in which table-creating for a vacant area is performed.

(A-2-2) Table-Creating for Vacant Area

The flowchart in FIG. 4B shows the concrete actions which are performed in the step S109 for table-creating for the vacant area.

First, base addresses of the respective vacant areas are detected (S109-1); and based on the base addresses thus detected, the size of the respective vacant areas are calculated (S109-2). The calculation of each size is performed by obtaining a difference between the neighboring base addresses of the page buffer areas and the work area, which are previously designated.

Next, vacant area management tables are created with respect to the respective vacant areas. For this purpose, each vacant area is divided into blocks (S109-3) (hereinafter, the action of dividing the vacant area into blocks is occasionally referred to as “block-dividing”). Block-dividing is performed by dividing the vacant area into a plurality of blocks by a unit block size. The unit block size is a fixed size of 8 MB in the case of monochrome, and of 34 MB in the case of color. These unit block sizes are determined to a monochrome buffer area, and to a color buffer area, respectively. These unit block sizes are adopted to ensure that, even where, in the course of data compression, the compression rate fails to increase to a desirable degree and accordingly the size of the image data remains the same as the size before compression in the worst case, the page whose compression has failed can be accumulated within one block. The block size may be made variable so that the vacant areas can be used efficiently. After the block-dividing is completed, each block is assigned with a management number, and a vacant area management table 30 is created for the vacant area (S109-4).

A vacant area management table 30 is created for each vacant area, as described above. Accordingly, if three vacant areas exist as in the case of the page memory 22 shown in FIG. 3B, one vacant area management table is created for each vacant area, that is, three vacant area management tables are created in total. By contrast, in the case of the extended page memory 22a, one vacant area management table is created because the entire memory 22a forms one vacant area. Note that, where there are a plurality of vacant area management tables, a configuration may be adopted in which an order of priority of use is assigned with each of the plurality of tables, and the tables are used according to the order of priority of use.

FIG. 5 shows an example of the vacant area management table 30. As shown in FIG. 5, in the vacant area management table 30, with respect to each block, there are provided management items of: management number (denoted as “No” in the drawing), start address (i.e., base address) (denoted as “Start Address” in the drawing), data size (denoted as “Data Size” in the drawing), and use flag (denoted as “Used” in the drawing).

Here, a management number is assigned to each block so that the management can be performed with respect to each block. Accordingly, when the user intends to specify an order of use among the blocks, his intention can be achieved by assigning management numbers to the blocks according to his desired order of use. The use flag shows whether or not the block is used, so that, when data is accumulated in a block, the use flag “1” is entered in the blank associated with the block.

Note that the above-described sequence of procedures in the table-creating is programmable. That is, the sequence of the procedures can be controlled in accordance with a program which executes the sequence of the procedures. Owing to this programmable configuration, changes can be made with respect to the unit block size and the order of priority among the vacant area management tables.

(A-2-4) Accumulation of Image Data

FIG. 4C shows a procedure, performed at the step S110, for accumulating image data into the vacant area management table 30. Specifically, each time one page of the manuscript is read by scanning, a block in the vacant area to be a destination to which the image data read by the scanning will be transferred is designated (S110-1), and the image data is transferred to the block. In this way, data of one page is accumulated in each block. With respect to the block in which image data is accumulated, the value representing the size of the image data thus accumulated is entered in the blank of the data size, and the blank of use flag is filled with “1”, which shows that the block is being used (S110-2). By way of the above procedure, each time the manuscript is read by the scanner 24 by one page, the image data is accumulated in each block, and accordingly the values of the management data of the image data are entered in the blanks of the items of the management data (i.e., data size, use flag); and these actions are continued till readings of all the pages of the manuscript are completed.

(A-2-5) Print-Output

After completing reading the manuscript, accumulating the image data into blocks, and storing of the management data into the vacant area management table 30, with respect to all the pages of the manuscript, print outputting at the step S109 is performed by using the vacant area management table 30. Since the management data stored in the vacant area management table 30 becomes unnecessary after completing print-outputting, the management data are deleted with respect to all the pages (i.e., management data are deleted with respect to all the blocks in which the management data are stored.).

Instead of performing the deletion of all the pages after completing the print-outputting at one time, the deletion of the management data in the vacant area management table 30 may be performed by each page after accumulation of the image and before the print-outputting. This configuration enables the user to optionally delete the pages which are scan-input but which he does not wish to print-output. This means that each block functions as one file.

Further, although, in the above explanation, the print-outputting is performed after completing accumulating data in the vacant area with respect to all the pages of the manuscript, a configuration may be adopted in which the accumulation of the image data into the vacant areas of a memory and the print-outputting are performed concurrently in a parallel manner. Specifically, when accumulation of the image data in the vacant area of the memory reaches a degree that the print-outputting can be started, the print-outputting is started; and thereafter, in parallel with accumulating image data for new pages in the vacant area of the memory, the image data which have already accumulated in the vacant areas of the memory are transferred to the printer so as to perform print-outputting.

(A-2-6) Copying Action

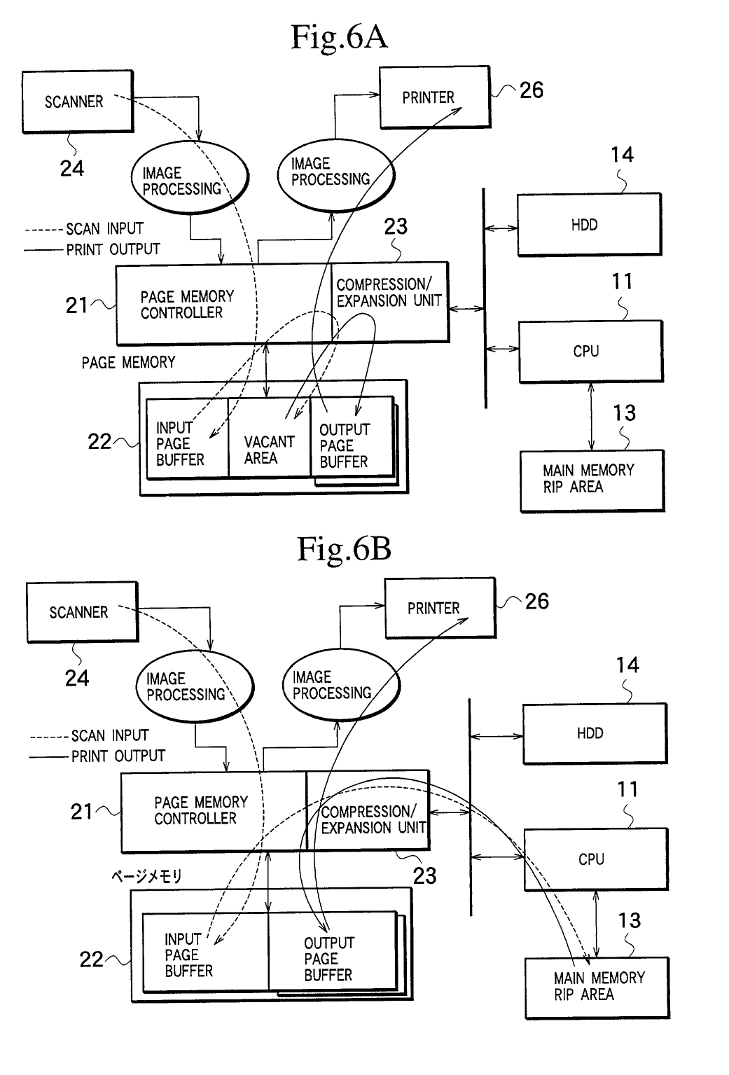

FIGS. 6A and 6B schematically show the transfer paths along which the image data are transferred when the copying action at the steps S108 to S111 is performed. Among these figures, FIG. 6A shows the transfer path in the case of monochrome, in which the vacant area of the page memory 22 is used. Specifically, during the period of scan-inputting (S106 to S108), the image data read through scanning by the scanner 24 is transferred by way of the image processing (which is performed by the scanner controller 25 and so on) and via the page memory controller (corresponding to the memory control unit 21 in FIG. 1), and input into the input page buffer in the page memory 22 and held therein. Thereafter, the data is transferred from the input page buffer via the page memory controller; compressed in the compression/expansion unit (corresponding to compression/expansion unit 23 in FIG. 1); accumulated in the vacant area of the page memory 22; and then management data of the image data is stored in the vacant area management table. When the print-outputting is performed (S109), the data stored in the vacant area of the page memory 22 is expanded at the compression/expansion unit, and once returned to the output page buffer in the page memory 22. Thereafter, the image data is transferred, via page memory controller and by way of the image processing (which is performed at the printer controller 27 and so on), to the printer 26.

On the other hand, in the case of color, as shown in FIG. 6B, the accumulation and transfer of the image data during the period when a copying action is performed by using the vacant area in the RIP area in the main memory 13. Specifically, at the time of scan-inputting, an image data is input and held in the input buffer of the page memory 22 through the same path as in the case of monochrome. Thereafter, the data is transferred from the input page buffer via the page memory controller, and subject to compression at the compression/expansion unit. Thereafter, unlike the case of monochrome, the image data is accumulated in the vacant area of the RIP area of the main memory 13 under the control of the CPU. At the time of print-outputting, the data accumulated in the RIP area of the main memory 13 is expanded by the compression/expansion unit, and once returned to the output page buffer of the page memory 22. Thereafter, similar to the case of monochrome, the image data is transferred, via the page memory controller and by way of the image processing performed at the printer controller 27, to the printer 26.

(A-2-7) Sequence of Actions and Operations in Entire Apparatus

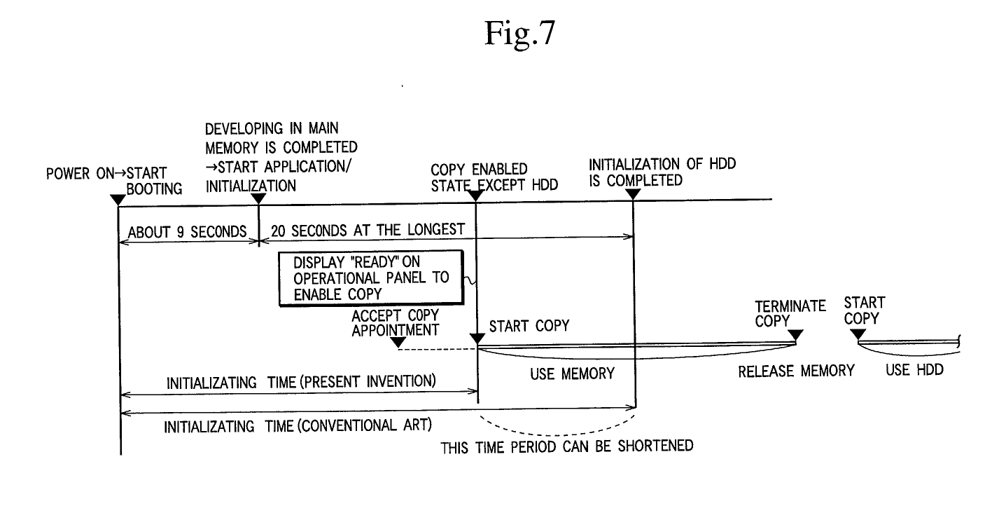

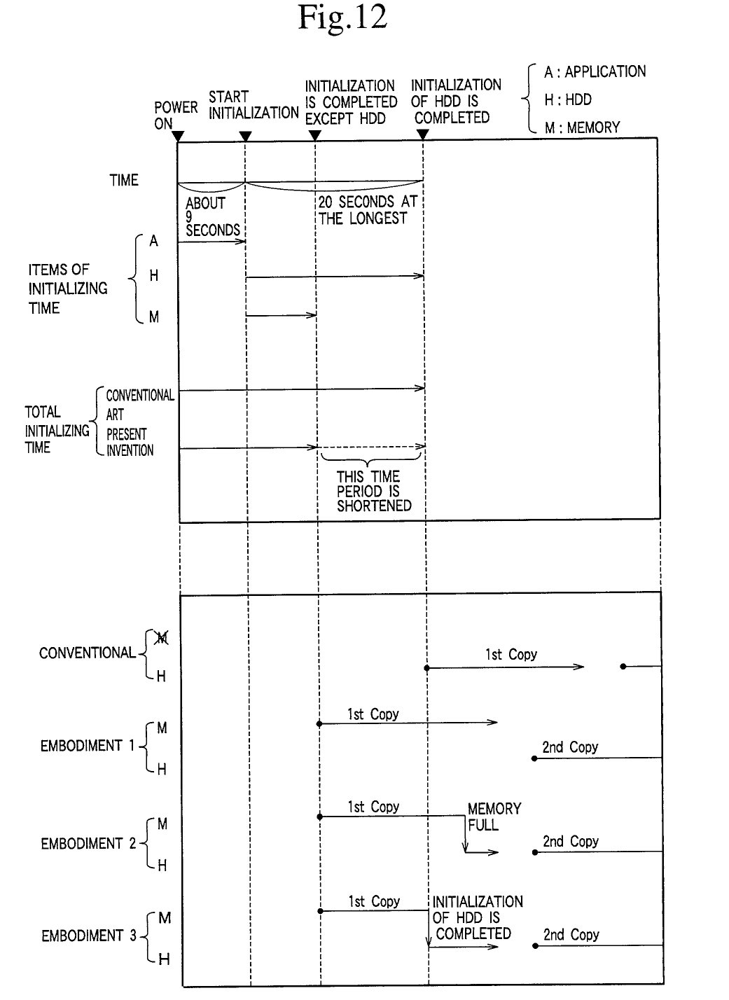

FIG. 7 is a time chart which shows the sequence of the actions performed by the apparatus and operations conducted by the user in the image forming apparatus 1 according to the first embodiment. FIG. 12 schematically shows the feature of the actions of the present embodiment in comparison with the other embodiments and conventional art (In FIG. 12B, the character string “1st Copy” denotes the copying action performed for the first time, “2nd Copy” denotes the copying action performed for the next time. The symbol “M” denotes a memory while “H” denotes HDD. The arrow of solid line shows, by its position where the arrow is depicted, whether the memory or HDD is being used as the accumulating destination of the image data when a copying action is performed.). As is clearly known from these drawings, the characteristic feature of the present embodiment is as follows: for the first copy, the copying action is started without awaiting completion of initialization of the accumulating unit by using the memory; and also even where the initialization of the accumulating unit is completed during the execution of the copying action, the copying action is continued by using the memory until the end of the copying action, and the copying action using the accumulating unit is started from the next copying for the first time.

Note that the present embodiment can be established on the premise that the allowable accumulation data amount is much larger than the required data amount, and that this embodiment can be sufficiently realized under the current technological level. This is because, for example, the vacant area of 96 MB in the case of monochrome corresponds to the data amount of 160 seconds (i.e., compressed image data of 120 pages of A4 manuscript), thus the amount of the vacant area being capable of sufficiently coping with ordinary data amounts of manuscripts.

(A-3) Advantages of First Embodiment

As detailed above, the first embodiment employs a constitution in which, when the entire apparatus (i.e., copy machine) except for the accumulating unit is put in a state in which a copying action can be performed, the copying action is started by using a vacant area existing in a memory. Owing to this constitution, the copying action can be started without awaiting completion of the time-consuming initialization of the accumulating unit, so that the time required for the initialization of the entire apparatus (copy machine) can be greatly shortened.

Further, the constitution is adopted in which the vacant area is managed by each block by using the vacant area management table, so that each block can be treated as one file; thus enabling efficient page management of the manuscript read by the apparatus (copy machine).

(B) Second Embodiment

Next, referring to FIGS. 1, 8, 9 and 12, the image forming apparatus according to the second embodiment of the present invention will be described.

(B-1) Constitution and Operations of Second Embodiment

The constitution of the image forming apparatus according to the second embodiment is the same as that of the first embodiment shown in FIG. 1, and the function of each member of the second embodiment is generally common to that of the corresponding member of the first embodiment. Accordingly, the members of the second embodiment common to those of the first embodiment are denoted by the same reference numerals, and the explanations of the common features are omitted.

A unique feature of the second embodiment different from the feature of the first embodiment is as follows: Where, during the printing operation in the first copying action, which is performed by using the vacant area of the memory, a memory full state (i.e., state in which the memory is filled up with data and accordingly data cannot be written therein any more) is reached, the accumulating destination is changed from the memory to the accumulating unit, and the copying action is continued.

The constitution of the second embodiment as described above is needed for the following reasons. Specifically, a state may arise in which the image data amount is so increased as to exceed the allowable amount of the vacant area, for example, in the cases: where the number of pages of the manuscript is large; where compression of the image data is not performed successfully; and where the image of the manuscript becomes extremely high-quality. Further, even where the required data amount is not changed, when only a memory of a small amount can be equipped, the required data amount may exceed the allowable data amount. In such cases, the memory full state is reached in the course of executing the copying action, so that the copying action using the vacant area of the memory as an accumulating destination cannot be continued any longer. For the above reason, the constitution of the second embodiment is needed in which, if the memory full state is reached in the course of executing the copying action while using the vacant area of the memory as an accumulating destination, the accumulating destination of the image data is changed from the vacant area of the memory to the accumulating unit, and then the copying action is continued.

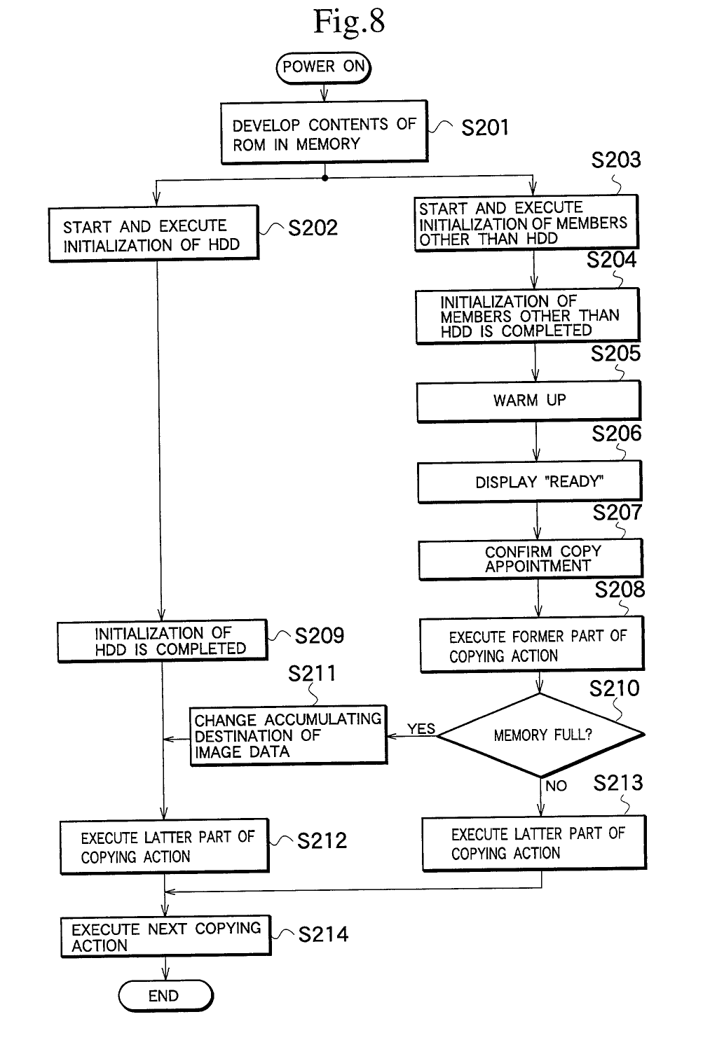

Hereinafter, the second embodiment will be described focusing on the characteristic features thereof. The flowchart in FIG. 8 shows the operations according to the second embodiment. In FIG. 8, the operations performed at the steps S201 to S207, and S209, which are executed after turning on the power are the same as the steps S101 to S107 and S109 of the first embodiment shown in FIG. 2, respectively, so that the explanations thereof are omitted. Similarly to the first embodiment, after confirming the copy appointment at the step S207, execution of the copying action is started (S208).

When a memory full state is detected in the course of executing copying action (S210), the destination to which the image data is transferred is changed from the vacant area of the memory to the accumulating unit 16 whose initialization is already completed (S211). Thereafter, a copying action is executed while keeping the accumulating unit 16 as an accumulating destination (S212) (Note that in FIG. 8, the copying action performed before the change of the accumulating destination of the image data, that is, the copying action performed while keeping the accumulating unit 16 as an accumulating destination, is referred to as “former part of copying action”; whereas, the copying action performed after changing the accumulating destination of the image data is referred to as “latter part of copying action”). Note that the case where the memory full state is not reached at the step S210 corresponds to the above-described first embodiment; and accordingly the accumulating destination is not changed, so that the copying action will be executed while keeping the vacant area of the memory as an accumulating destination of the image data till the copying action is completed (S213).

After this operation, the copying action is executed while keeping the accumulating unit as an accumulating destination of image data. Accordingly, if an appointment for the next copying action is registered, the next copying action is executed (S214), and the subsequent copying actions will be treated similarly.

Note that, in the present embodiment, the sequence, in itself, of the copying action executed at the steps S208, S210 to S212 is executed in a continuous manner without an interruption within the apparatus. This is because, although the change of the accumulating destination (S211) occurs during the sequence, only the accumulating destination is changed, and the change is executed momentarily.

Further, a configuration may be adopted in which, when the change of the accumulating destination of the image data is performed (S212), the image data already accumulated in the memory is concurrently transferred from the memory to the accumulating unit. This configuration ensures that the processing load applied on the apparatus is reduced because, when the accumulated image data is transferred to the printer in the print-outputting, all that needs to be done is to access the accumulating unit only. Not to mention, the following configuration may be adopted. Specifically, the image data accumulated before the change of the accumulating destination are left in the memory, and the image data after the change of the accumulating destination are accumulated in the accumulating unit; and an accessing destination to the accumulated image data at the time of printing is changed according to where the image data is accumulated. In either case, releasing of the memory is performed when the memory is not needed for the subsequent operations related to the accumulated image data. Specifically, in the former configuration, the memory is released at the time when the image data disappears from the memory as a result of the change of the accumulating destination and the transfer of the already accumulated image data from the memory; whereas, in the latter case, the memory is released when the print-outputting is completed with respect to all the accumulated image data in the memory.

The “copying action” executed at the steps S208 and S212, in which the change of the accumulating destination of the image data (S211) is executed in between, refers to the sequence of the actions performed at steps S108 to S111 shown in FIG. 2, which are described in the first embodiment. Note that the change of the accumulating destination (S211) is executed chiefly at the step of accumulating the image data (S110). Nevertheless, the actions performed at the steps S208 and S212 is referred to as “copying action”; because the image data is needed to be held till the print-outputting (S111) to be subsequently performed; and because, as described in the first embodiment, the manner that the scan-input and the print-output are executed concurrently may be executed, and accordingly the procedure to which the change of the accumulating destination of the image data (S211) relates is not restricted to the stage in which the image data is accumulated (S110).

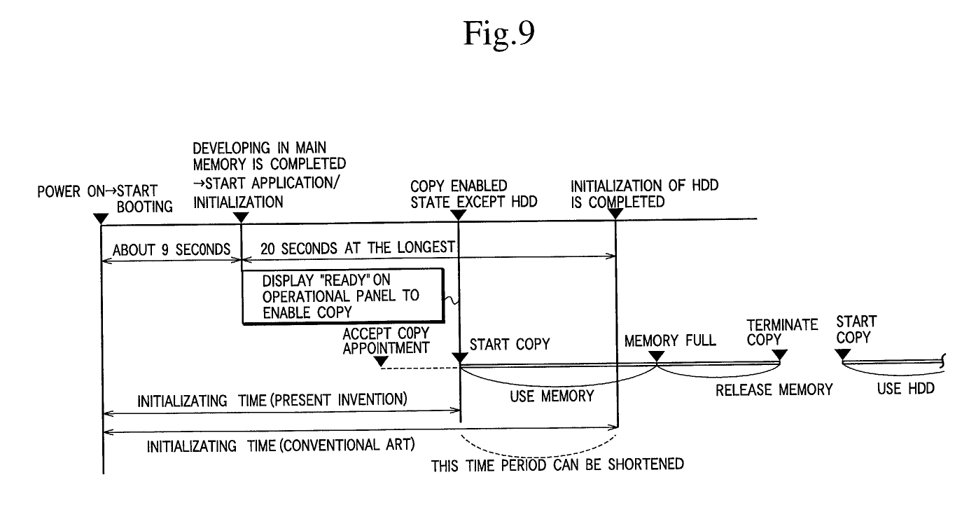

The time chart in FIG. 9 shows the time-based order of the sequence of the actions performed by the apparatus and operations conducted by the user in the second embodiment detailed above. FIG. 12 shows the characteristic features of the actions of the present embodiment in comparison with the other embodiments and conventional art.

Note that, although, in the present embodiment, the accumulating destination is changed at the moment when the memory reaches the memory full state, the moment when the change of the accumulating destination is performed is not restricted thereto. For example, the change may be performed at the moment when data is accumulated up to a predetermined ratio of the vacant area of the memory (for example, 70% of the vacant area).

(B-2) Advantages of Second Embodiment

As described above, according to the second embodiment, since the configuration is adopted in which, when the memory becomes full, the accumulating destination of the image data is changed from the memory to the accumulating unit, the copying action can be completed even where the image data amount becomes extremely larger than the allowable accumulation amount because, for example, the number of pages of the manuscript is so increased that the memory capacity becomes short.

(C) Third Embodiment

Next, referring to FIGS. 1, 10, 11 and 12, the image forming apparatus according to a third embodiment of the present invention will be described.

(C-1) Constitution and Operations of Third Embodiment

The constitution of the image forming apparatus according to the third embodiment is the same as that of the first embodiment shown in FIG. 1, and the function of each member of the third embodiment is generally common to that of the corresponding member of the first embodiment. Accordingly, the members of the third embodiment common to those of the first embodiment are denoted by the same reference numerals, and the explanations of the common features are omitted.

A unique feature of the third embodiment, which is different from those of the first and second embodiments, is as follows: In the course of performing a printing operation for the first copy by using the vacant area of the memory, when initialization of the accumulating unit is completed, the accumulating destination of the image data is changed from the memory to the accumulating unit, and then the copying action is continued. The third embodiment is common to the second embodiment in that the accumulating destination is changed. By contrast, the third embodiment is different from the second embodiment in that, in the third embodiment, even where the memory full state is not reached, the change is executed when initialization of the accumulating unit is completed.

The reason why the constitution of the third embodiment is needed is as follows: Where occurrence of a memory full state is expected at a high probability, for example, where the number of pages of the manuscript is large, and where compression ratio does not increase (i.e., data compression is not performed successfully); it is more reliable and efficient that change of the accumulating destination of the image data is executed when the initialization of the accumulating unit is completed so that the apparatus reaches a usable state.

Hereinafter, the third embodiment will be described while focusing on the characteristic features thereof.

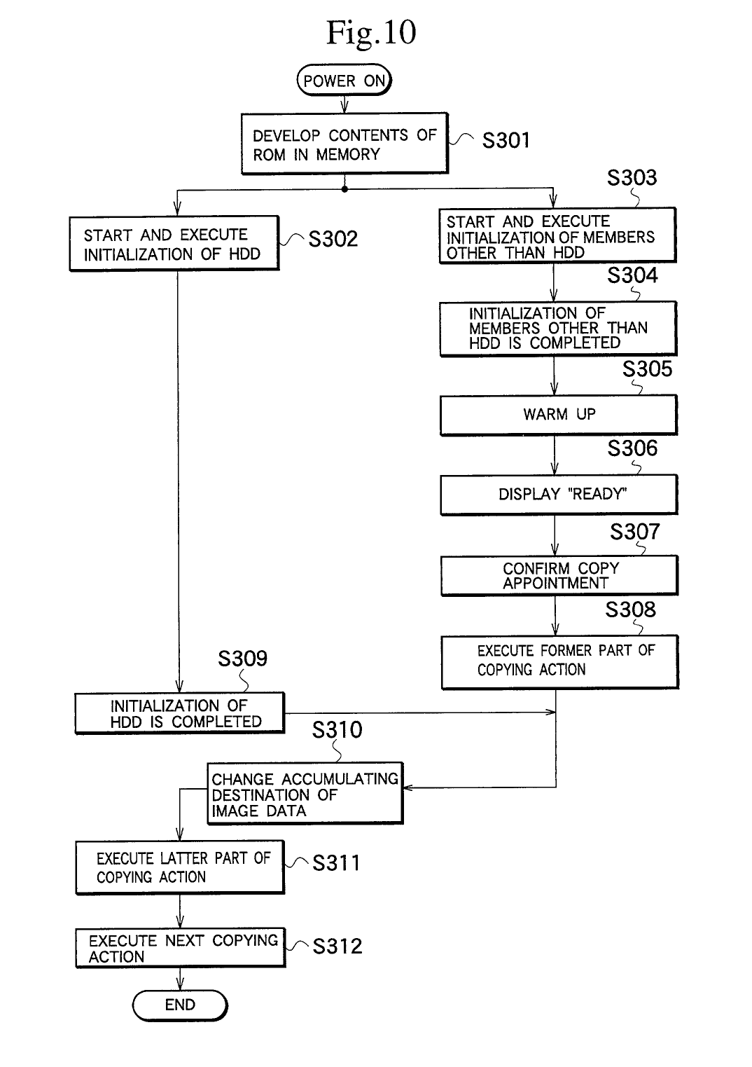

The flowchart of FIG. 10 shows the operations according to the third embodiment. In FIG. 10, the operations of steps S301 to S306, which are performed after turning on the power, are the same as those at the steps S101 to S106 of the first embodiment in FIG. 2, so that the explanations thereof are omitted. After a copy appointment is confirmed at step S307, the execution of a copying action will be started, as in the first embodiment (S308).

When the initialization of the accumulating unit is detected during the period when the copying action is being performed (S309), the accumulating destination is changed from the vacant area of the memory to the accumulating unit 16 (S310); and thereafter, the copying action is continued while keeping the accumulating unit 16 as the accumulating destination of the image data (S311) (Note that in FIG. 10, the copying action performed before the change of the accumulating destination is referred to as “former portion of copying action”, while the copying action performed after the change of the accumulating unit is referred to as “latter portion of copying action”.).

The third embodiment is the same as the second embodiment with respect to: the feature that the copying action performed at the steps S308, S310 and S311, which is executed while bridging the change of the accumulating destination of the image data (S310) executed in between, is performed in an uniterrupted continuous manner; whether or not the image data, which is already accumulated in the memory, is transferred when the accumulating destination is changed; the timing when the memory is released; and the contents of copying action.

Thereafter, the copying action is executed while using the accumulating unit 16 as the accumulating destination of image data. Accordingly, when an appointment of a next copying action exists, the next copying action is executed (S312) while using the accumulating unit 16 as a accumulating destination; and the subsequent copying actions are executed in the same manner.

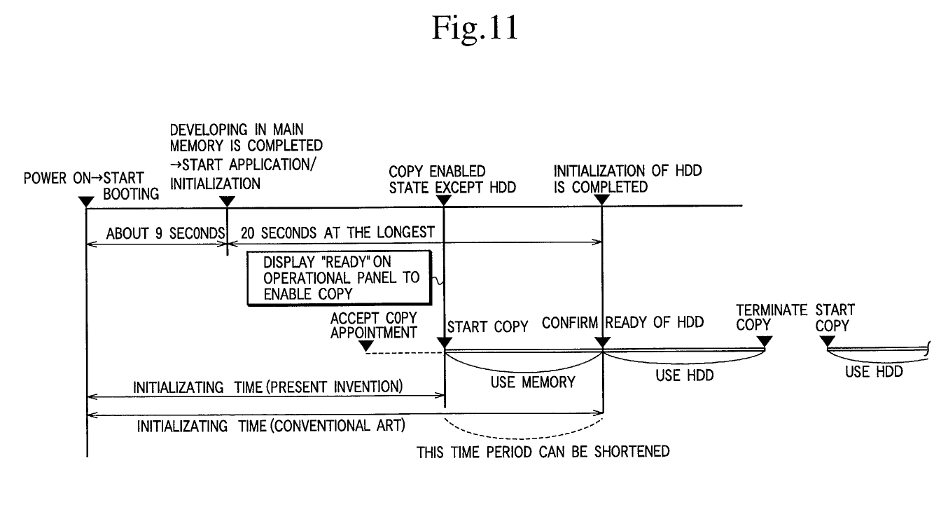

The time chart in FIG. 11 shows the sequence of actions performed by the apparatus and operations conducted by the user in the third embodiment, which are detailed above. FIG. 12 shows the feature of the present embodiment in comparison with the other embodiments and conventional art.

(C-2) Advantages of Third Embodiment

In the third embodiment, regardless of whether or not a memory full state is reached, when the initialization of the accumulating unit is completed, the accumulating destination of the image data is changed from the vacant area of the memory to the accumulating unit. Owing to this constitution, even where the data amount of the image is extremely large, the copying action can be executed reliably and efficiently.

(D) Other Embodiments

(D-1) In the above-mentioned embodiments, the constitution is adopted in which, after the object-document is read, a memory which has a vacant area according to the data amount of the manuscript is selected and a management table is created. However, where the memory is in a usable state, the vacant area management table can be created even before the manuscript is read. Accordingly, a configuration may be adopted in which, when the initialization of the memory is completed and the memory itself becomes a usable state, a vacant area management table is created for each vacant area thus detected, and thereafter a manuscript is read. In this case, it is preferred that the block size is made variable so that the apparatus can cope with both a monochrome manuscript and a color manuscript. Further, it is preferred that an order of priority is assigned to each of a plurality of vacant management tables so that the vacant management tables can be used according to the order of priority.

(D-2) Further, in the above embodiment, the vacant area in a semiconductor memory, which is usually used as an accumulating destination before completion of initialization of the accumulating unit, is used as a substitute of the accumulating unit, the member to be used as a substitute is not restricted thereto. For example, a specific semiconductor memory which is used only for accumulating image data is newly provided, and the specific semiconductor memory is used as an accumulating destination of the image data.

(D-3) Further, the above-mentioned explanation is made on an assumption that the present invention is applicable chiefly to a separate independent digital copy machine, the objects to which the present invention is applied are not restricted thereto.

For example, it is as a matter of course that the present invention is applicable to a MFP (multi function peripheral) which is provided with a copying function and connected to a network. Further, the present invention is applicable to a system in which various functions of a copy machine (for example, scan-inputting function, print-outputting function) are provided in a scattered manner within a network.

Further, the present invention is applicable to a single printer machine. This is because the important feature of this invention is that a semiconductor memory is used as a temporary substitute of the hard disk drive, and accordingly it does not matter through which process the input image data is obtained; and consequently the present invention is applicable to a system in which an image data is obtained not through the scan-inputting function.

Further, any apparatus in which the storage means (for example, HDD) having a mechanical factor is used as a part of the entire apparatus, and accordingly the time-consuming initialization of the storage means serves as a factor of hindering shortening of the initializing time of the entire apparatus.

(E) Advantages of the Invention

According to the present invention, since the accumulating action of the input image data and the outputting action of the accumulated image data, which are performed in the copying action, and so on, can be started without awaiting the initialization of the accumulating unit which takes a long time, the initializing time of the entire image forming apparatus can be greatly shortened.

What is claimed is:

1. An image forming apparatus in which an input image data is accumulated and an outputting action is performed on the basis of the accumulated image data, comprising:
first storage means for storing input image data;
second storage means whose initializing time is shorter than the initializing time of the first input means;
storage control means which causes, when the second storage means becomes operable before completion of the initialization of the first storage means, the accumulating action of the input image data and the outputting action of the accumulated image data to start while designating, in place of the first storage means, the second storage means as an accumulating destination.

2. The image forming apparatus according to claim 1, wherein
the number of the second storage means is one or more;
the storage control means:
selects second storage means which serves as an accumulating destination of the input image data on the basis of the data amount of the input image data and the allowable data amount of the one or more second storage means; and
accumulates the input image data into any one of the one or more vacant areas formed in the second storage means thus selected.

3. The image forming apparatus according to claim 2, wherein
the storage control means:
divides the vacant area of the selected second storage means into a plurality of blocks;
accumulates the input image data into each of the blocks obtained by the dividing by an amount of a unit page; and
manages the plurality of blocks by each block.

4. The image forming apparatus according to claim 1, wherein
even where the initializing action of the first storage means is completed during the period when the accumulating action is being executed while keeping the second storage means designated as an accumulating destination, the accumulating action and the outputting action are continued while keeping the second storage means as the accumulating destination of the input image data till the accumulating action and the outputting action are completed.

5. The image forming apparatus according to claim 1, wherein
where a cause of indisposing accumulation into the second storage means arises during the period when the accumulating action is being executed while keeping the second storage means designated as an accumulating destination, the accumulating destination of the input image data is changed from the second storage means to the first storage means, and the accumulating action is continued.

6. The image forming apparatus according to claim 1, wherein
where the initializing action of the first storage means is completed during the period when the accumulating action is being executed while keeping the second storage means designated as an accumulating destination, the accumulating destination of the input image data is changed from the second storage means to the first storage means, and the accumulating action is continued.

7. An image forming method by which input image data is accumulated and an outputting action is performed on the basis of the accumulated image data, comprising:
providing first storage means for storing input image data and second storage means whose initializing time is shorter than the initializing time of the first storage means;
causing, when the second storage means becomes operable before completion of the initializing the first storage means, the accumulating action of the input image data and the outputting action of the accumulated image data to start while designating, in place of the first storage means, the second storage means as an accumulating destination.

8. The image forming method according to claim 7, wherein
the number of the second storage means is one or more;
second storage means which serves as a destination of the accumulation of the input image data is selected on the basis of the data amount of the input image data and the allowable data amount of the one or more second storage means; and
the input image data is accumulated in any one of the one or more vacant areas formed in the second storage means thus selected.

9. The image forming method according to claim 8, wherein
the vacant area of the selected second storage means is divided into a plurality of blocks;
the input image data is accumulated into each of the blocks thus obtained by an amount of a unit page; and
the plurality of blocks are managed by each block.

10. The image forming method according to claim 7, wherein
even where the initializing action of the first storage means is completed during the period when the accumulating action is being executed while keeping the second storage means designated as an accumulating destination, the accumulating action and the outputting action are continued while keeping the second storage means as the accumulating destination of the input image data till the accumulating action and the outputting action are completed.

11. The image forming method according to claim 7, wherein
where a cause of indisposing the accumulation into the second storage means arises during the period when the accumulating action is being executed while keeping the second storage means designated as an accumulating destination, the accumulating destination of the input image data is changed from the second storage means to the first storage means, and the accumulating action is continued.

12. The image forming method according to claim 7, wherein
where the initializing action of the first storage means is completed during the period when the accumulating action is being executed while keeping the second storage means designated as an accumulating destination, the accumulating destination of the input image data is changed from the second storage means to the first storage means, and the accumulating action is continued.

13. An image forming apparatus in which input image is copied and output, comprising:
an accumulating unit for accumulating input image data;
a temporary storage unit whose initializing time is shorter than the initializing time of the accumulating unit;
a control unit which causes, when the temporary storage means becomes operable before completion of the initialization of the accumulating unit, the accumulating action of the input image data and the outputting action of the accumulated image data to start while accumulating input image data into the temporary storage means in place of the accumulating means.

14. The image forming apparatus according to claim 13, wherein
the number of the temporary storage unit is one or more;
the control unit:
selects a temporary storage unit which serves as a destination of the accumulation of the input image data on the basis of the data amount of the input image data and the allowable data amount of the one or more temporary storage unit; and
accumulates the input image data into any one of the one or more vacant areas formed in the temporary storage unit thus selected.

15. The image forming apparatus according to claim 14, wherein
the control unit:
divides the vacant area of the selected temporary storage unit into a plurality of blocks;
accumulates the input image data into each of the blocks thus obtained by an amount of a unit page; and
manages the plurality of blocks by each block.

16. The image forming apparatus according to claim 13, wherein
even where the initialization of the accumulating unit is completed during the period when the accumulating action is being executed while accumulating input image data in the temporary storage unit, the copying action is continued while keeping the temporary storage unit as the accumulating destination of the input image data till the copying action is completed.

17. The image forming apparatus according to claim 13, wherein
where a cause of indisposing accumulation into the temporary storage unit arises during the period when the copying action is being executed while accumulating input image data in the temporary storage unit, the accumulating destination of the input image data is changed from the temporary storage unit to the accumulating unit, and the copying action is continued.

18. The image forming apparatus according to claim 13, wherein
where the initialization of the accumulating unit is completed during the period when the copying action is being executed while accumulating input image data into the temporary storage unit, the accumulating destination of the input image data is changed from the temporary storage unit to the accumulating unit, and the accumulating action is continued.
